(19) United States
(12) Patent Application Publication
(10) Pub. No.: US 2025/0371564 A1
(43) Pub. Date: Dec. 4, 2025

(54) CUSTOMIZED PRODUCT BUNDLES

(71) Applicant: STRIPE, INC., South San Francisco, CA (US)

(72) Inventors: Eliot Abrams, New York, NY (US); Kathleen Kranzlin, Jersey City, NJ (US)

(21) Appl. No.: 18/732,081

(22) Filed: Jun. 3, 2024

(51) Int. Cl. G06Q 30/0202; G06Q 20/22; G06Q 30/0601

(52) U.S. Cl. CPC G06Q 30/0202; G06Q 20/227; G06Q 30/0631

(57) ABSTRACT

A method includes receiving one or more features characterizing; a first user; one or more features characterizing a geographic region; and a selection of product offerings offered by a platform; computing specific predictions for the selection of product offerings to be adopted by the first user, each specific prediction being computed for a corresponding product offering of the selection of product offerings by: selecting a specific model for the corresponding product offering corresponding to the one or more features characterizing the geographic region, trained based on training data collected by the platform; and supplying the one or more features characterizing the first user to the specific model to compute the specific prediction; and computing an aggregated prediction from adopting the selection of product offerings based on the specific predictions, the aggregated prediction being smaller than the sum of the specific predictions for the selection of product offerings.

### BACKGROUND

Consumers and businesses face growing options of available goods and services even from single providers. Some providers simplify the decision process for customers by assembling bundles of popular products.

The above information disclosed in this Background section is only for enhancement of understanding of the present disclosure, and therefore it may contain information that does not form the prior art that is already known to a person of ordinary skill in the art.

### SUMMARY

The present disclosure is directed to customized product bundles, substantially as shown in and/or described in connection with at least one of the figures, as set forth more completely in the claims.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram depicting the relationships between revenue uplift models according to embodiments of the present disclosure, historical transaction data and A/B testing data for training the revenue uplift models, computing predictions based on the revenue uplift models, and user interfaces for presenting the outputs of the revenue uplift models, according to some embodiments of the present disclosure.

FIG. 2 is an example of a user interface to interact with a revenue uplift prediction system according to one embodiment of the present disclosure.

FIG. 3 is a flowchart depicting a method for training a revenue uplift specific model, according to one embodiment of the present disclosure.

FIG. 4 is a flowchart of a method for computing of a predicted revenue uplift for a merchant based on adopting a selected collection of product offerings (e.g., additional payment methods and/or product features or payment products of the payment processing platform), according to one embodiment of the present disclosure.

FIG. 5 is a schematic diagram illustrating the effect of overlap in adopting multiple product offerings and avoiding double counting revenue increases when computing aggregated revenue uplift according to one embodiment of the present disclosure.

FIG. 6 is a block diagram illustrating a high-level network architecture of a computing system environment for operating a processing system according to embodiments of the present disclosure.

FIG. 7 is a block diagram illustrating a representative software architecture, which may be used in conjunction with various hardware architectures as described herein.

FIG. 8 is a block diagram illustrating components of a processing circuit or a processor, according to some example embodiments, configured to read instructions from a non-transitory computer-readable medium (e.g., a non-transitory machine-readable storage medium) and perform any one or more of the methods discussed herein.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Merchants face a complex business environment with respect to handling payments from customers. Payment methods used by various customers may include personal checks, automated clearinghouse (ACH) transfers, credit cards (over multiple different payment networks), electronic payment providers, mobile payment providers, mobile carrier billing (e.g., via providers of mobile telephony services), buy-now-pay-later (BNPL) payments, voucher-based payments such as payments made at convenience stores (e.g., Konbini payments), and the like. These payment methods may be local to geographic regions (e.g., individual countries or groups of countries), may be associated with different customer markets in their relevant geographic regions, or may be associated with particular types of merchants (e.g., business-to-consumer sales versus business-to-business sales and/or based on whether individual orders have relatively small or relatively large monetary values).

Therefore, some payment methods may enable access to entirely new segments of the customer market and therefore the adoption of those payment methods are likely to produce substantial revenue increases (or revenue uplift), while other payment methods may be entirely redundant with the payment methods currently accepted by the merchant (e.g., because substantially all customers who use that payment method are already willing and able to conduct business with the merchant using existing payment methods). Some payment methods may be in between and provide merely a small revenue uplift. Merchants choose bundles of payment methods to invest resources into adding to their systems to maximize the value added (e.g., revenue increase). Including payment methods that are popular in target markets may substantially increase revenue, while adding payment methods that are unpopular in those target markets may have little to no benefit.

Engaging in regional or global commerce therefore requires a merchant to be able to handle payments from a wide variety of customers that may have different preferences or access to payment methods. In a case where M different merchants need to be able to accept N different payment methods, this may require M times N different customized integrations between the front-end electronic store operated by the merchants and the N different back-end payment method systems.

Electronic payment hubs or electronic payment platforms provide payment methods, merchants, and their customers with improved experiences in processing electronic payments (e.g., electronic commerce over the internet). An electronic payment platform or electronic payment hub may be implemented using computer software executed by one or more processing circuits of one or more computer servers (referred to herein as a computer system), thereby configuring the computer system to implement a special purpose machine configured to process electronic payments. The computer system of the electronic payment platform may be connected to a computer network, such as the internet, and exchange information with payment methods through that computer network.

A given merchant seeking to accept payments from customers can integrate their computer systems with the electronic payment platform using one or more application programming interfaces (APIs) provided by that electronic payment platform. Such an integration may include, for example, including a user interface component in a checkout portion of an application or app and/or on a checkout web page of a website operated by the merchant. That merchant can then use the electronic payment platform to accept payments from customers. In more detail, the user interface component may provide a customer with options to pay using one or more different payment methods (e.g., credit card, debit card, bank account, or buy-now-pay-later). The customer may make the payment using one of these payment methods or, in some cases, the merchant may allow the customer to divide the payment across multiple payment methods (e.g., pay a portion of the total using a bank account and the remainder using a credit card). The electronic payment platform passes information collected through the user interface component to the payment methods to process the payments, such as transferring funds from a customer account and transferring those funds to a merchant account, and where the electronic payment platform and the payment processor (or payment processors) charge associated payment processing fees for the service.

While the electronic payment platform may support and/or provide access to many different payment methods, the merchant may choose a subset of those payment methods to offer to its customers. For example, some payment methods may not be relevant to the merchant's target market, and an excess number of payment methods may negatively impact the customer's experience in the checkout process.

Furthermore, the electronic payment platform may offer other features to merchants, such as fraud detection, payment card authorization improvements (e.g., reducing the likelihood of payment card charges being declined by a corresponding bank), smart ordering of the available payment methods (e.g., based on the likelihood of the consumer to select a given payment method, such as based on popularity) and a simplified checkout process for customers (e.g., automatically filling information for a customer based on information stored from a prior transaction involving the customer that was processed by the electronic payment platform).

However, it can be difficult for a merchant to determine payment methods to offer to its customers and which enhanced features from the electronic payment platform to adopt. A merchant's choices as to which payment methods to accept can have an impact on that merchant's sales as well as costs. For example, accepting cash payments at a brick-and-mortar allows the merchant to serve customers who choose to operate on a cash basis. As another example, accepting credit card payments through different credit card networks enables the merchant to service customers carrying credit cards that operate on those networks. Some payment methods may be associated with specific markets, such as payment methods that are popular with customers in specific geographic regions (e.g., specific countries), age groups, sub-cultures (e.g., whether to accept payments via cryptocurrencies), and/or whether the customer is a business (a business-to-business or B2B transaction) or an individual (a business-to-consumer or B2C transaction). Payment methods that involve extending credit to the buyer, such as buy-now-pay-later payments (which provide short term loans to customers who pay for goods in installments spread over the following few weeks, where the merchant may pay a fee for providing this service, similar to a credit card fee), may be preferred by customers who have relatively lower cash savings.

Each of these different payment methods may be associated with different types of overhead. For example, paper currency may require counting cash receipts, depositing the cash at a bank, maintaining a supply of cash to make change, and the like. Credit cards involve the payment of transaction fees, which may vary between networks and involve managing payment disputes, where different credit card networks may be associated with different dispute rates. Buy-now-pay-later may have higher fees than credit cards and therefore may reduce the margins earned by a merchant that accepts such payments.

This array of different possibilities makes it difficult for a merchant to understand which payment methods to accept. Similar considerations apply when a merchant chooses from among product features of the electronic payment platform to adopt (e.g., whether a fraud detection feature will provide a net increase in revenue by reducing the rates of chargebacks or losses). One consideration for a merchant is whether an increase in revenue through access to additional customers offsets the higher overhead of managing that additional payment method and/or the fees charged by that payment method.

This problem of choosing which payment methods to accept is exacerbated by cultural and geographic differences when expanding to different markets. For example, the collection of payment methods used to handle payments in a merchant's home country may not match with the payment method preferences of customers in another country or region within that country. It may be difficult for a merchant to understand which of the available payment methods to accept in a given target country or geographic region that would best increase or maximize the customer reach.

Similar considerations arise when a merchant weighs whether subscribing to a particular product feature of the electronic payment platform will result in sufficient increased revenue to offset its cost. Furthermore, different combinations of payment methods and product features may result in different levels of revenue uplift in non-linear ways, as will be discussed in more detail below.

Some merchants rely on advice from sales agents to make these decisions. Case studies, such as the revenue uplift seen by a merchant after adopting a particular payment method or feature of the electronic platform, can provide some evidence to convince other merchants. However, the relevance of these case studies to any given merchant is ambiguous, as that merchant's circumstances may not align with those of the case study.

Accordingly, aspects of embodiments of the present disclosure relate to computing customized revenue uplift predictions for a merchant based on accepting payments through a set (or group) of payment methods (a package of payment methods) and features supported by the electronic payment platform. In more detail, aspects of embodiments of the present disclosure relate to a computing model for predicting revenue uplift of a merchant over time after adopting a given payment method or product feature of the electronic payment platform. In some embodiments of the present disclosure, separate models (or revenue uplift specific models that are specific to corresponding payment methods or product features) are trained for each of a plurality of different payment methods and each product feature, such that separate revenue uplift predictions or specific predictions can be computed for each of the different payment methods. As will be described in more detail below, these revenue uplift specific models may be trained on causal inference based on historical data, actively managed A/B tests, and combinations thereof. Some aspects relate to training these revenue uplift specific models based on data collected by the electronic payment platform, such as revenue changes after merchants adopt various payment methods (e.g., after a merchant makes a new payment method available to its customers).

Some aspects of embodiments of the present disclosure further relate to aggregating the separate revenue uplift predictions for a package of payment methods, accounting for overlap (or cannibalization) of potential revenue uplift between the different payment methods and product features, to compute an overall predicted revenue uplift for a merchant adopting the package of payment methods and product features.

Some additional aspects of embodiments of the present disclosure relate to presenting the computed results, such as by providing sales agents and merchants with a user interface for exploring the expected revenue uplift from adding different combinations of payment methods and product features along with user interfaces for generating and displaying recommendations for a package of payment methods and product features to accept to increase (or maximize) the corresponding expected revenue uplift (e.g., where adding further payment methods is not expected to significantly further increase revenue).

As described in more detail below, embodiments of the present disclosure relate to addressing a particular problem arising from the broad reach enabled by computer networking technology (e.g., the internet), which allows access to customer markets in different geographic regions across the world. These different customer markets have local preferred payment methods that are culturally foreign to merchants based in other countries (whereas a merchant may readily understand which payment methods are typically used by customers in its own geographic region). Aspects of embodiments of the present disclosure relate to a technological solution, where transaction data automatically collected by a electronic payment platform and/or A/B testing data collected during A/B test actively launched by the payment processing platform are used to train a statistical model (e.g., a machine learning model) to predict the revenue uplift or revenue increase associated with adopting particular payment methods and product features (e.g., bundles of payment methods and product features) under various conditions (e.g., in a particular geographic market). These statistical models are also trained to account for a variety of additional conditions associated with the target customers of the merchant, such that the estimated revenue uplifts are tailored for the circumstances of each merchant. The automatic training process is also further updated and refined based on additional data as it is collected by the electronic payment platform such that it continues to improve and adapt to changes in the popularity of different payment methods and other changes in market conditions.

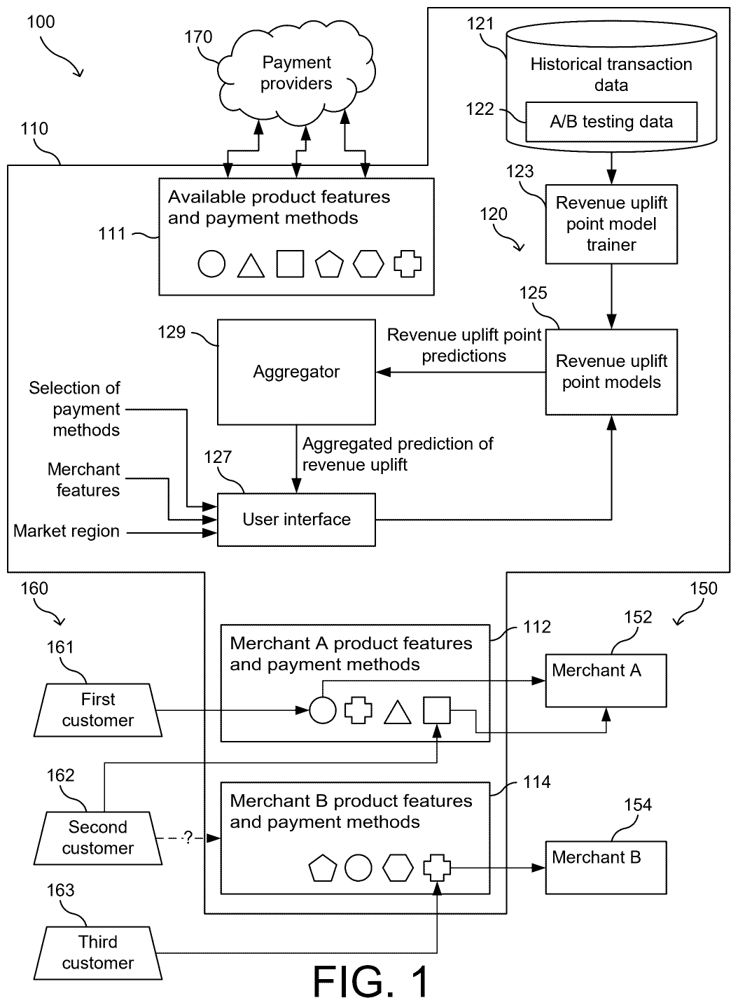

FIG. 1 is a block diagram depicting the relationships 100 between revenue uplift models according to embodiments of the present disclosure, historical transaction data for training the revenue uplift models, computing predictions based on the revenue uplift models, and user interfaces for presenting the outputs of the revenue uplift models, according to some embodiments of the present disclosure.

Some aspects of embodiments of the present disclosure relate to electronic payment hubs or electronic payment platforms, implemented by computer systems, that simplify the process of coordinating between merchants and payment methods. A payment processing platform 110 shown in FIG. 1 is implemented using one or more computer servers having instructions stored in one or more memories of the computer systems, where the instructions, when executed by one or more processors of the one or more computer servers, implement the systems and methods described in more detail below.

Merchants 150 may choose to integrate their front-end electronic stores with the payment processing platform 110, such that they can accept payments from customers 160. The payment processing platform 110 has established relationships with various payment providers 170, which may communicate with the payment processing platform 110 over a communication network (e.g., the internet) and using various protocols, such as automated clearing house (ACH) protocols, electronic checks, wire transfers, and application programming interfaces (APIs) defined by the payment providers 170 and/or the electronic payment platform. These connections with payment providers 170 may be represented as available product features and payment methods 111 that are supported by the payment processing platform 110. (The example of FIG. 1 uses six different shapes to generally refer to six different payment methods, although embodiments of the present disclosure are not limited to six payment methods and generally there may exist dozens or hundreds of possible payment methods.) These payment methods may include, for example, credit card payments, debit card payments, electronic payments, bank transfers (e.g., wire transfers and/or ACH transfers), different providers of buy-now-pay-later (BNPL) payments, other forms of credit offerings, and the like. Any given payment provider may support one or more different payment methods (e.g., a same payment provider may support processing both debit card payments and credit card payments, and another payment provider may support both electronic payments and a buy-now-pay-later payment method).

This greatly reduces the engineering effort required on the part of the merchant to provide their customers with a range of payment options, as the merchant does not need to develop software integrations with each such payment method, and instead can integrate their front-end stores (e.g., brick and mortar stores and/or electronic commerce stores implemented in a web application and/or in a mobile application) with the payment processing platform 110. In more detail, a merchant can select a group of payment methods from among the available product features and payment methods 111 to offer to its customers 160, based on which payment methods are preferred by the customer base. A merchant may also select one or more electronic platform product features, which may be manifested, for example, as changes to the user experience or user interfaces presented to customers during the checkout process (e.g. streamlined checkout processes where customers who previously used a checkout process implemented by the payment platform have personal information already saved in the platform) and/or as changes to the processing of the transactions by the payment processing platform 110 (e.g., fraud detection and prevention). The product features and payment methods are examples of payment product offerings from the payment processing platform 110 to merchants and may be referred to herein as product offerings.

As noted above, it may be difficult for a merchant to understand which payment methods would be preferred by its customers in a given market, especially when expanding to new markets (e.g., expanding to a foreign country), where cultural norms may be different. In the example shown in FIG. 1, first customer 161 and second customer 162 may both make purchases from merchant A 152 using different payment methods from among the product features and payment methods 112 offered by merchant A, which merchant A 152 selected from among the available product features and payment methods 111. Likewise merchant B 154 offers its customers a different set of product features and payment methods 114, where third customer 163 makes purchases using one of those payment methods. However, second customer 162 may find that merchant B 154 does not offer any of their preferred payment methods among the product features and payment methods 114, and therefore may choose not to do business with merchant B 154. This results in a lost potential sale. The product features adopted by merchant A 152 and merchant B 154 may also impact revenue in various ways, such as where simplified checkout product can improve conversion rates (e.g., the rate at which consumers complete purchase transactions) or where a fraud detection product can improve revenue due to reduced fraud rates (e.g., due to chargebacks). The product features and payment methods 112 adopted by merchant A 152 and the product features and payment methods 114 adopted by merchant B 154 may therefore have different impacts on revenues earned by different merchants.

Similarly, it may be difficult for a merchant to understand which product features of the payment processing platform 110 to offer to its customers as it may be difficult to estimate how the presence of these product features may impact (e.g., improve) sales conversions (e.g., increase the likelihood that a given customer will complete a transaction with the merchant).

Accordingly, aspects of embodiments of the present disclosure relate to computing predictions of revenue uplift or revenue increase due to the adoption of additional product offerings (e.g., additional payment methods and/or product features). For example, the expected revenue uplift to merchant B 154 if merchant B were to offer additional payment methods from the available product features and payment methods 111 that are not among the currently offered payment methods 114, such as by adopting a payment method that the second customer 162 is willing to use. In some embodiments, the predictions are computed using a revenue uplift prediction system 120 implemented in one or more computer systems of the payment processing platform 110 and trained based on historical transaction data 121 collected by the payment processing platform 110 through the course of handling payment transactions between merchants 150 and payment providers 170. While aspects of embodiments of the present disclosure are presented in the context of product offerings of a payment platform, the present disclosure is not limited thereto and may also be applied to bundles of other types of products, such as from platforms providing software-as-a-service (Saas) products in fields such as cloud computing services, data storage, customer relationship management, project management, and the like. The types of historical transaction data 121, such as A/B testing data 122 collected during A/B tests, will be described in more detail below.

As shown in FIG. 1, the uplift prediction system includes a revenue uplift specific model trainer 123 that uses the historical transaction data 121 (and, in some cases, the A/B testing data 122) to produce revenue uplift specific models 125 for specific corresponding product features or payment methods. Each of the revenue uplift specific models 125 is trained to predict the revenue uplift that a merchant is expected to see over some period of time (e.g., 6 months or one year, or year-over-year) after adopting a specific corresponding additional product offering (payment method from among the available product features and payment methods 111 or product feature of the payment processing platform 110). Accordingly, each revenue uplift specific model is associated with a specific corresponding one of the available product features and payment methods 111 or one of the product features of the payment processing platform 110.

In various embodiments, the revenue uplift specific model trainer 123 includes multiple types of trainers. Some trainers relate to using causal inference methods based on historical data collected during the normal course of business, and some trainers relate to using actively run experiments (e.g., A/B testing experiments) to compute models. Some aspects of embodiments of the present disclosure relate to using inverse-variance weighting (a statistical technique) to combine these estimates from the causal inference methods with the A/B testing methods. In more detail, some aspects of embodiments relate to computing multiple estimates of the revenue uplift from any one payment method or product feature and combining these multiple estimates into one specific estimate. In some embodiments, these specific estimates are expressed as ranges that represent the uncertainty associated with any given specific estimate. For example, a revenue uplift specific estimate for a given payment method or product feature may be represented by the 90% confidence interval of the revenue uplift from that product. Further aspects of embodiments relate to combining the specific estimates corresponding to each payment method or product feature into one aggregated estimate (e.g., an aggregated number) for the entire bundle of products.

The predicted revenue uplift for a given merchant will depend on various factors, such as the geographic region in which this payment method will be offered, and various merchant features describing, for example, a merchant business segment or market segment associated with the merchant (e.g., business-to-business versus business-to-consumer, average checkout cart size, whether the merchant is selling a subscription service with recurring transactions, and the like). In some embodiments, the revenue uplift specific models take one or more merchant features as input, and in some embodiments, separate models are trained for different merchant business segments or market segments (e.g., separate revenue uplift specific models are trained for different geographic regions or for different types of businesses).

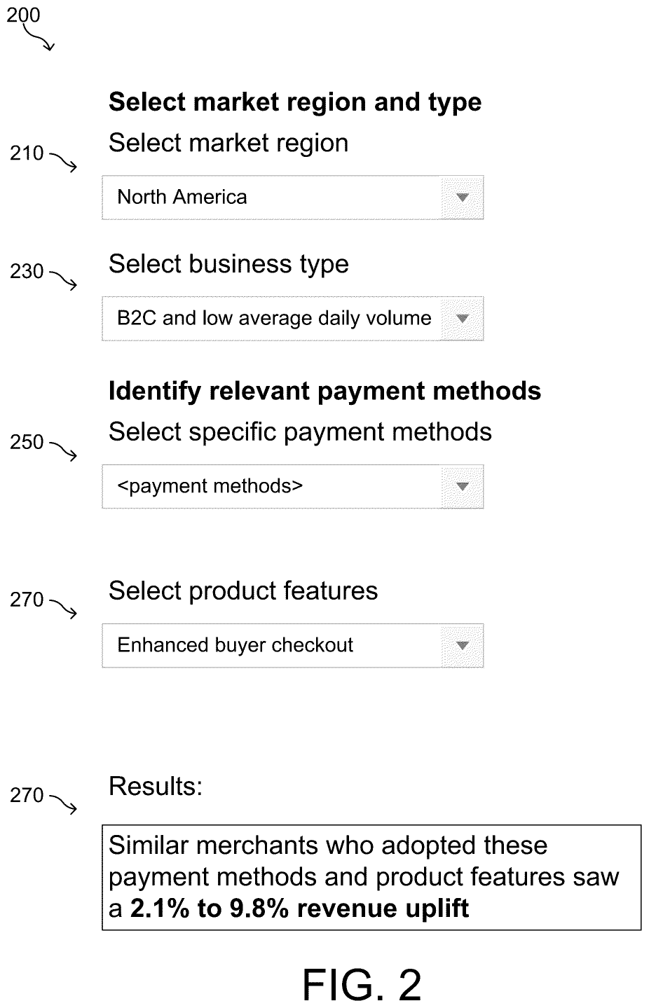

A user interface 127 is used to receive information regarding the revenue predictions to be made, such as identification of the geographic market region for the prediction and information regarding merchant features such as the merchant business segment or the market segment. The user interface 127 also receives a selection of payment methods to be adopted by the merchant. FIG. 2 is an example of a user interface 200 to interact with a revenue uplift prediction system 120 according to one embodiment of the present disclosure. In the example shown in FIG. 2, a market region user interface control 210 affords selection of a market region targeted by the merchant (shown in FIG. 2, as set to North America), a business type user interface control 230 affords selection of a business type (shown in FIG. 2 as set to B2C (business-to-consumer) with low average daily volume, and which includes other options as discussed in more detail below), a payment method selection user interface control 250 through which a user can select one or more payment methods that are being considered for adoption by the merchant, and a product features user interface control 270 (shows in FIG. 2 as having enhanced buyer checkout as a selected product feature).

The selection of payment methods, the merchant features, and the market region are supplied to the revenue uplift specific models 125 to select the appropriate models (e.g., the models corresponding to the selected payment methods) and to compute revenue uplift specific predictions. The selection is performed automatically by the computer system implementing the revenue uplift prediction system 120 based on these features including the selection of payment methods, the merchant features, and the market region. Each specific prediction represents the expected revenue increase (or revenue uplift) associated with adopting a corresponding payment method from among the selected payment methods (e.g., identified in the selection of payment methods), referred to as specific predictions because each payment method corresponds to a specific product rather than multiple products.

The aggregator 129 aggregates the revenue uplift specific predictions to compute an aggregated prediction of revenue uplift from adopting the selected payment methods and electronic platform product features. In some embodiments, the aggregator 129 computes the aggregated prediction of revenue uplift accounting for redundancies or overlap in adopting multiple additional payment methods, because each incremental or marginal payment method added to those accepted by the merchant offers diminishing returns that may depend on the payment type. For example, a given customer may use multiple different payment methods and may conduct business with the merchant so long as the merchant accepts at least one of those payment methods. Adopting another payment method generally does not increase the amount of business that customer conducts with the merchant for the same types of goods and services (e.g., a customer may be indifferent between paying by credit card versus electronic payment), but may be encouraged to purchase different goods (e.g., higher-priced goods) when credit-based payment methods (e.g., buy-now-pay-later) are offered. The resulting aggregated prediction of revenue uplift is then provided to the user interface 127, such as in a results portion 290 of the user interface 200, such that a user (e.g., a merchant or a sales representative for the payment processing platform 110) can understand how the selection of payment methods and product features is predicted to impact revenue for the merchant (e.g., as shown in FIG. 2, the message: “Similar merchants who adopted these payment methods and product features saw a 2.1% to 9.8% revenue uplift”).

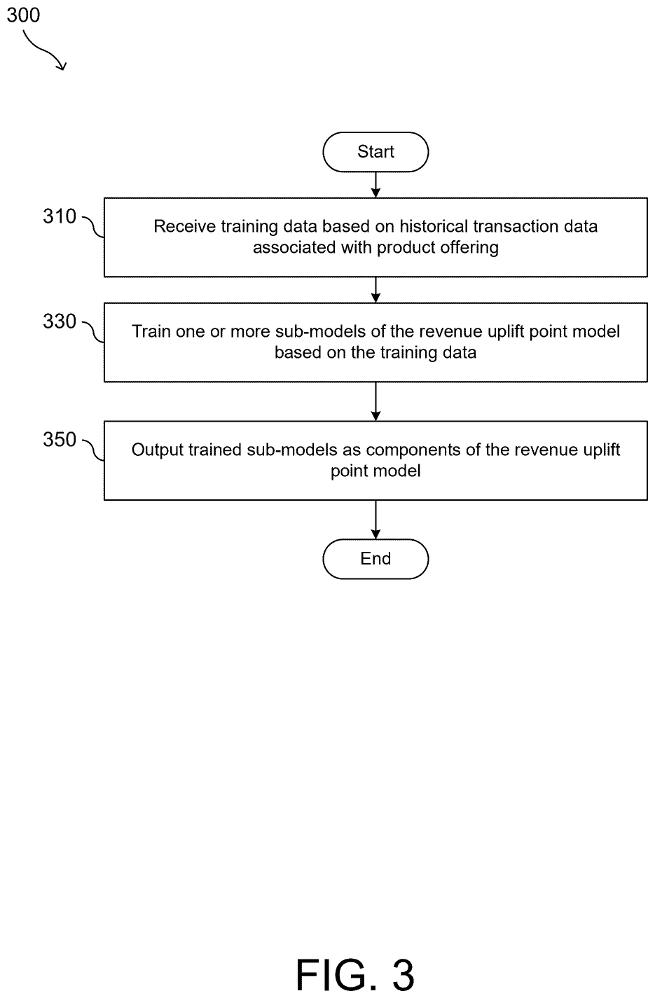

FIG. 3 is a flowchart depicting a method 300 for training a revenue uplift specific model, according to one embodiment of the present disclosure. In some embodiments of the present disclosure, the operations of method 300 are performed by a computer system including one or more processing circuits and having instructions stored in one or more memories that, when executed by the one or more processing circuits, configure the computer system to implement a revenue uplift specific model trainer 123 of the revenue uplift prediction system 120.

In some embodiments, the revenue uplift specific model is trained to compute estimates or predictions of revenue uplift based on holdback training data (or A/B testing data 122 collected during A/B experiments) and based on difference-in-difference analyses.

Holdbacks or A/B experiments refer to circumstances where experiments are run using an payment processing platform 110 processing customer transactions for merchants. A holdback is an experiment in which a particular product offering (e.g., a particular payment method or a particular product feature) is hidden or held back from a customer during a transaction, such that a consumer does not see the held-back payment method or does not experience the product feature during a payment process with a merchant, even though the merchant has otherwise enabled the payment method or product feature. Conducting holdback experiments randomly across numerous transactions defines two groups of consumers—a control group of consumers who were shown that payment method or experienced the product feature (group A) and a treatment group of consumers who could not use that held-back payment method or who did not experience the product feature (group B). To reduce the impact on merchants (e.g., due to lost sales), in some embodiments the treatment group (group B) is much smaller than group A (e.g., 1% of transactions are randomly selected to be part of a holdback experiment and the remaining 99% are experience the standard checkout process, and where the holdback experiment is performed for a limited time period, such as 1 month or 6 months).

Based on the A/B testing data 122 from these A/B tests, the revenue uplift specific model trainer 123 constructs a model of the effect of the presence or absence of the product feature or payment method on consumer behavior, as will be described in more detail below.

Difference-in-difference analysis relates to matching merchants who adopted a particular product feature or payment method with merchants who did not and comparing the difference in their revenues over time. A higher similarity between the merchants (apart from the adoption of the product feature or payment method) improves the quality of the predictions made by these difference-in-difference analyses, as will be discussed in more detail below.

At 310, the revenue uplift specific model trainer 123 receives training data for training a revenue uplift specific model of the revenue uplift specific models 125. As noted above, in some embodiments, a given revenue uplift specific model is specific to a particular payment method or product feature of the payment processing platform 110 and may be further narrowed to specific market regions (e.g., geographic areas) or other aspects such as specific business types. As such, the training data for training the revenue uplift model is filtered to data that is relevant for training such a model. These include, filtering the data based on different payment methods, such as specific local payment methods (e.g., payment methods that are only available in particular geographic regions or that are more widely adopted in particular geographic regions, even if those payment methods are available outside of those particular geographic regions), buy-now-pay-later payment methods, bank transfers (e.g., ACH and wire transfers), credit card and debit card payment methods, and the like.

The data may also be filtered or tagged based on specific business segments or market segments, which may be represented as merchant features describing characteristics of the merchant. In some embodiments, a merchant involved in a transaction may be tagged as a business-to-business (B2B) merchant, a business-to-consumer (B2C) merchant, a business-to-business-to-consumer (B2B2C) merchant facilitating transactions between third party producers and consumers (e.g., an electronic marketplace), and the like. The merchants may also be tagged based on average order value (AOV) or average transaction size.

At 330, the revenue uplift specific model trainer 123 constructs one or more revenue uplift specific sub-models based on the training data.

In some embodiments, one such sub-model is a holdback sub-model trained based on A/B testing data 122 based on the holdback or A/B experiment described above. In some embodiments, to calculate revenue uplift from a corresponding product offering (a payment method or a product feature), the revenue uplift specific model trainer 123 computes the total revenue divided by the number of tokens for the treatment group (for which the product offering was held back) versus the control group (for which the product offering was shown to the consumer). Here, a token generally refers to a given transaction or a given customer depending on the type of product offering being held back, examples of which are provided below. The increase in revenue per token is equivalent to the increase in revenue for the merchant under the assumptions that (1) the treatment does not cause a change in the number of tokens each merchant sees and (2) the revenue counted for each token is attributable to a single merchant. Due to both implementation and conceptual differences, each holdback has slightly different revenue and token definitions.

For example, the payment processing platform 110 may provide a card authorization optimization product offering. (In some examples, a card authorization optimization product offering tracks patterns of successful authorizations and erroneous declines and uses the collected information to format messages to banks in a manner that improves authorization rates, thereby reducing the chance that a customer will abandon the transaction due to the erroneous decline.) In the context of a card optimization product offering, a token may be a specific credit card number. As another example, a given payment method may be tracked using a checkout and payment session identifier (session ID), which may be generated for the customer session during the interaction with the front-end user interface (e.g., a browser session or a session created through a mobile application when connecting to the payment processing platform 110 to make a payment).

A given sub-model may be trained based on the training data to compute a predicted revenue uplift from adopting a product offering (a given payment method or a given product feature of the payment processing platform 110). Because the historical transactions will show a variety of different outcomes for different merchants (e.g., different merchants may experience different amounts of revenue change or conversion rate based on the presence or absence of the tested product offering), there is some uncertainty and an interval or range of possible outcomes. Accordingly, in some embodiments of the present disclosure, the revenue uplift specific sub-model outputs an interval associated with a distribution of possible revenue increases or revenue uplift (e.g., 2.3% to 4.7%), where the distribution of possible revenue uplift values has a statistical variance computed based on the historical training data. The interval may correspond to, for example, a 90% confidence interval based on the population of merchants operating in the same market region and having the same set of merchant features such as: B2B versus B2C versus B2B2C; low average order volume versus high average order volume (such as below $1000 USD versus above $1000 USD or equivalent), high margin versus low margin merchants (e.g., profit margin above 15% versus below 15%).

Some aspects of embodiments of the present disclosure relate to training, at 330, a sub-model of the revenue uplift specific model based on observational data using synthetic controls or difference-in-difference methods. A synthetic control method relates to evaluating the effect of an intervention in comparative case studies by constructing a weighted combination of groups using controls. The synthetic controls do not correspond to any merchants that were involved in the historical transaction data 121. In contrast, a difference-in-difference method according to some embodiments of the present disclosure relates to identifying merchants that are most similar to one another, as described by its merchant features, with the exception of the adoption of the product offering (the payment method or the product feature of the payment processing platform 110). The difference-in-difference sub-model is then trained to predict or estimate these differences in revenue or revenue growth between these merchants based on adopting the product offering.

For example, the payment processing platform 110 may offer a card payment user interface component that accepts only credit card or debit card information from a customer and may later offer a multi-payment method user interface that accepts electronic payment providers in addition to credit or debit card information. Merchants may choose to remain on the original card payment user interface or may choose to migrate to the multi-payment method user interface. The historical transaction data 121 collected by the payment processing platform 110 includes transaction data from merchants before and after adopting multi-payment method user interface. A difference-in-difference approach relates to identifying pairs of merchants that are similar (e.g., the most similar merchants) except for the adoption of the multi-payment method user interface.

When applying such a difference-in-difference sub-model, the sub-model identifies a merchant pair that is most similar to a given merchant, as described by its merchant features, and uses the revenue increase of the merchant adopting the product offering over the non-adopting merchant in the merchant pair to estimate the revenue uplift for the given merchant. In some embodiments, the matching of merchants is performed based on, but not limited to: country, merchant industry, merchant segment (or market segment), merchant revenue, monthly revenue growth, number of transactions, and average order volume (AOV).

A similar approach may be applied, for example, to merchant adoption of particular payment methods in specific market regions. For example, each merchant using the payment processing platform 110 who have over 200 transactions per month and who have adopted a given payment method at some point in the trailing 2 years may be matched to a similar merchant on the payment processing platform 110 who did not adopt that payment method, based on the matching variables detailed below and months active. The revenue uplift specific model trainer 123 then computes the difference in the monthly revenue between the adopters and the non-adopters after adoption minus the difference in the monthly revenue between the adopters and the non-adopters before adoption. Under the assumption that adopters and matched non-adopters would have had similar monthly revenue growth trends in the counterfactual world where the adopters did not adopt the payment method, this difference-in-difference estimate is the causal revenue uplift due to adopting the payment method.

In some embodiments, the variables for matching merchants include, but are not limited to: merchant revenue, number of purchases, average order volume, average month-over-month change (or growth) in revenue, average month-over-month change in number of purchases, merchant region (or market region), and merchant segment (or market segment).

In some embodiments, training the difference-in-difference sub-model includes training a regression model (e.g., a linear regression model) relating the revenue growth to adoption of the product offering.

Some merchants accept payments through payment rails other than the payment processing platform 110. As a result, the historical transaction data 121 contains only the portion of a given merchant's payment volume that is processed by the payment processing platform 110. This limited visibility can cause the difference-in-difference analysis to overestimate the revenue uplift that a merchant experiences when adopting a payment method on the payment processing platform 110. For example, consider a merchant who is processing cards on the payment processing platform 110 and processing an electronic payment method via another payment processor. If this merchant decided to move their electronic payment method volume to the payment processing platform 110 then, from the perspective of the payment processing platform 110, the entirety of the electronic payment method volume appears to be net new—and it is new to the payment processing platform 110. However, from the merchant's perspective none of the electronic payment method volume is net new because it was already being processed through another system. The merchant did not get a revenue uplift from adopting the electronic payment method on the payment processing platform 110 because, of course, the merchant was already processing that electronic payment method off the payment processing platform 110.

In some embodiments, the sub-model further includes a deflation factor that accounts for this overlap. For example, the electronic payment provider may communicate to the payment processing platform 110 that ˜70% of the electronic payment provider's volume that is processed through the payment processing platform 110 volume is not net new to the electronic payment provider. As such, the difference-in-difference sub-model deflates the revenue uplift estimate for that electronic payment provider accordingly.

At 350, the revenue uplift specific model trainer 123 outputs the trained sub-models as components of the revenue uplift specific model that is being trained, where the trained revenue uplift specific model is added to the stored revenue uplift specific models 125 of the revenue uplift prediction system 120.

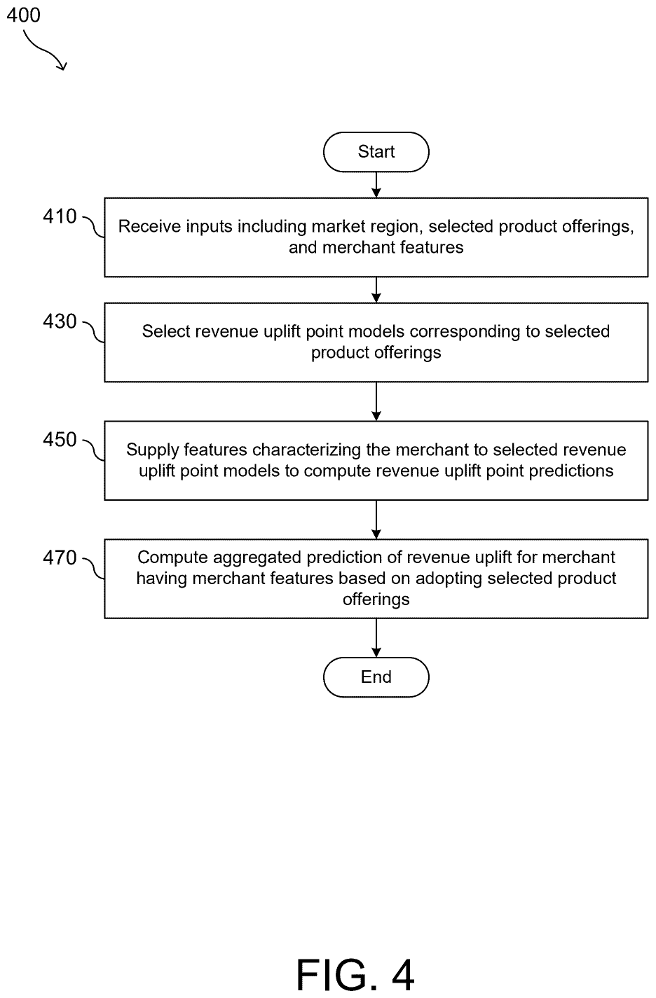

FIG. 4 is a flowchart of a method 400 for computing of a predicted revenue uplift for a merchant based on adopting a selected collection of product offerings (e.g., additional payment methods and/or product features of the payment processing platform 110), according to one embodiment of the present disclosure. In some embodiments of the present disclosure, the operations of method 400 are performed by a computer system including one or more processing circuits and having instructions stored in one or more memories that, when executed by the one or more processing circuits, configure the computer system to implement portions of the revenue uplift prediction system 120 including the user interface 127, the computation of results using the revenue uplift specific models 125, and computation of aggregated predictions of revenue uplift using an aggregator 129, as will be described in more detail below.

At 410, the revenue uplift specific models 125 receive inputs regarding the selected product offerings and market region information, where these inputs may be provided by the user interface 127 or some other source (e.g., saved inputs from a previous run or batch inputs from a batch operation computing multiple predictions).

At 430, the appropriate ones of the revenue uplift specific models 125 are selected for computing revenue uplift specific predictions based on the received inputs, including the selected product offerings. As noted above, each revenue uplift specific model is trained for corresponding product offering. In some embodiments, there are multiple revenue uplift specific models trained for any given product offering, where different ones of these revenue uplift specific models are trained for different markets, such as different market regions and/or different market segments associated with the merchant (e.g., B2B versus B2C, high AOV vs low AOV, and the like).

At 450, the one or more features characterizing the merchant are supplied to the one or more selected revenue uplift specific models to compute the revenue uplift specific predictions from the adoption of the corresponding selected product offerings by the merchant. As noted above, the revenue uplift specific models 125 are trained based on historical transaction data and therefore the predictions are statistical predictions that have some uncertainty. These uncertainties may be represented in the outputs of these models where, instead of outputting a single value as the predicted revenue impact (e.g., a percentage increase in revenue such as 3.1%), the models may output an interval of values (e.g., a range representing potential increases in revenue such as 0.8% to 6.2%). This interval of values may correspond to the 90% confidence interval of the prediction (or other confidence intervals, such as 95% confidence interval or 68% confidence interval), based on the variability of the revenue uplift as observed in the historical transaction data 121. Representing the output as such an interval for distribution of values may help merchants to better understand the meaning of the predictions, such as by managing expectations if their observed revenue uplift is closer to the low end of the reported intervals.

At 470, the aggregator 129 computes an aggregated prediction of revenue uplift for a merchant having the merchant features based on adopting the selected product offerings.

As noted above, in some embodiments of the present disclosure, the revenue uplift specific models 125 may include both holdback sub-models and difference-in-difference sub-models, and the multiple estimates computed by the different sub-models are combined into a single estimate per product offering using use inverse-variance. In more detail, for each estimate for a given product offering, the combined revenue uplift specific estimate is computed based on a weighted average of the revenue uplift estimates from the sub-models, where the weight given to each estimate from a sub-model is the inverse of the estimate's variance. This approach minimizes the variance of the final estimate and, if the estimates are normally distributed, this choice corresponds to the maximum likelihood estimate for the true value. In more practical terms, this approach emphasizes a precise revenue uplift estimate.

In some embodiments, the historical transaction data 121 may not hold sufficient information to generate revenue uplift estimates that are statistically significant. For example, in some embodiments a “not enough data” response is generated by the sub-model when a difference-in-difference sub-model is based on fewer than 25 merchants or when a holdback model is based on fewer than 1,000 randomization tokens. In such cases, then, in some embodiments, the estimated revenue uplift may be reported as being between 0% and an estimate of the 1 standard error (SE) from the available data.

As discussed above the revenue uplift specific estimates report the effect of adopting one new product offering while holding everything else about the merchant fixed. As a result, the payment method revenue uplift specific estimates each reflect the uplift from adding only the one payment method. When a merchant adds multiple payment methods that are strong substitutes for each other, the overall uplift will be smaller than the sum of the individual estimates. The country or market region-specific nature of many payment methods limits this concern for most payment method families. However, different BNPLs may be substitutes for each other (despite their differing customer base, financing options, and payment experience).

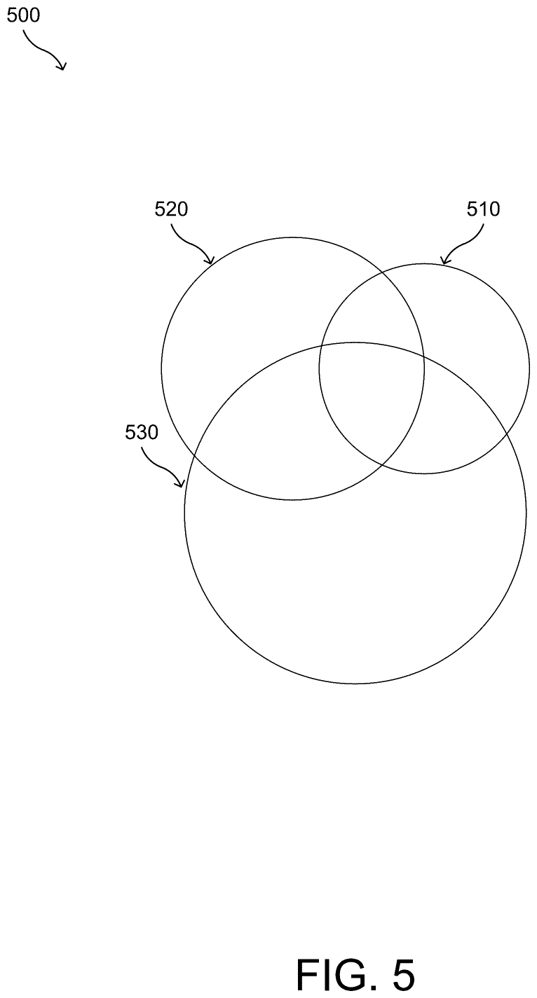

To account for this, in some embodiments, the aggregated prediction of revenue uplift is smaller than the sum of the plurality of revenue uplift specific predictions for the plurality of product offerings. This is because, as noted above, there may frequently be overlap in the impact of adopting different product offerings in helping a given customer complete a transaction. FIG. 5 is a schematic diagram illustrating the effect of overlap in adopting multiple product offerings and avoiding double counting revenue increases when computing aggregated revenue uplift according to one embodiment of the present disclosure. The example of FIG. 5 will be described in the context of three different BNPL providers but approaches according to embodiments of the present disclosure are not limited thereto and may also be applied to other payment methods and/or other product features.

In FIG. 5, a first circle 510 represents the net new end payers who would use the smallest BNPL if it was the only one present (i.e., the BNPL that provides the smallest revenue uplift when considered alone). A second circle 520 represents the net new end payers who would use the middle BNPL if it was the only BNPL available. A third circle 530 represents the net new end payers who would use the largest BNPL if it was the only one present.

The revenue uplift from adding multiple BNPLs as payment options is determined by how these circles overlap. In some embodiments, the historical transaction data 121 is used to model how these circles overlap (e.g., how the addition of a given payment method increases revenue for a merchant if they already offer a specific different payment method). In some embodiments of the present disclosure, where there is insufficient data to model these overlaps, one approach is to assume that any larger circle covers about 50% of any smaller circle (in other words roughly half of the net new end payers using a smaller BNPL when it is the only BNPL available, would have used a larger BNPL if it was the only BNPL available), and that the largest circle covers about 50% of the full outer join of the two smaller circles (in other words, roughly half of the net new end payers using the smaller BNPLs when they are the only BNPLs available, would have used the larger BNPL if it was the only BNPL available).

In some embodiments, the aggregator 129 sums across the revenue uplift specific estimates for individual payment methods to report the total revenue uplift from adopting the selected payment methods. Similarly, the aggregator 129 sums across the product feature-level estimates to report the overall uplift from the product features (or payment products). In some embodiments, the aggregator 129 applies either the bottom of the interval, the top of the interval, or some point within the interval towards the sum. In some embodiments, the midpoint of each interval is used when calculating the sum of the revenue uplift specific estimates.

Some aspects of embodiments further relate to limiting or capping the estimated revenue uplift to report for adopting payment methods. Because each payment method revenue uplift specific estimate reports the revenue uplift that an average merchant (in a region and business segment or market segment) would see from adopting the payment method, adding atypical combinations of payment methods or abnormally many payment methods can produce nonsensical results (e.g., exceeding the size of the addressable market in the region). For example, because no one merchant would add all of the available product features and payment methods 111 offered by the payment processing platform 110, the sum across all of the revenue uplift specific estimates is unrealistically large. Accordingly, in some embodiments of the present disclosure the aggregator 129 reports that the revenue uplift due to adopting the selected payment methods is greater than 10% (e.g., 10%+) if the sum of the individual payment method revenue uplift specific estimates exceeds 10%. The maximum reported increase may be different from 10% (e.g., 15%) or smaller than 10% (e.g., 8%), as appropriate for the setting merchant expectations for revenue uplift.

Accordingly, aspects of embodiments of the present disclosure relate to systems and methods for predicting revenue uplift from adopting one or more product offerings of a payment processing platform, where these product offerings include payment methods and payment product features offered by the payment processing platform. In various embodiments, the estimate is computed based on revenue uplift specific estimates for individual product offerings, where the revenue uplift specific estimates are computed using revenue uplift specific models, and there revenue uplift specific models are trained based on historical transaction data collected by the payment processing platform in the course of processing payment transactions on behalf of merchants across a variety of market segments and market regions (e.g., geographic regions). Accordingly, aspects of embodiments of the present disclosure may be used to provide customized guidance to merchants as to which products to adopt.

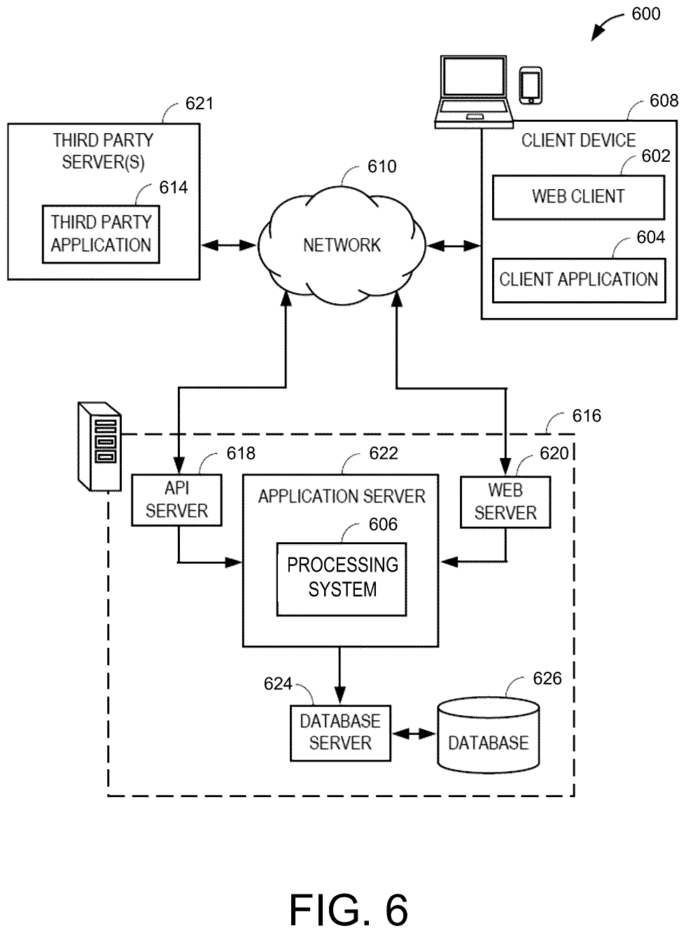

With reference to FIG. 6, an example embodiment of a high-level SaaS network architecture 600 is shown. A networked system 616 provides server-side functionality via a network 610 (e.g., the Internet or a WAN) to a client device 608. A web client 602 and a programmatic client, in the example form of a client application 604 (e.g., client software for providing or accessing the user interface 127 of the revenue uplift prediction system 120), are hosted and execute on the client device 608. The networked system 616 includes one or more servers 622 (e.g., servers hosting services exposing remote procedure call APIs), which hosts a processing system 606 (such as the processing system described above according to various embodiments of the present disclosure supporting service for automatically processing accounting data) that provides a number of functions and services via a service oriented architecture (SOA) and that exposes services to the client application 604 that accesses the networked system 616 where the services may correspond to particular workflows. The client application 604 also provides a number of interfaces described herein, which can present an output in accordance with the methods described herein to a user of the client device 608.

The client device 608 enables a user to access and interact with the networked system 616 and, ultimately, the processing system 606. For instance, the user provides input (e.g., touch screen input or alphanumeric input) to the client device 608, and the input is communicated to the networked system 616 via the network 610. In this instance, the networked system 616, in response to receiving the input from the user, communicates information back to the client device 608 via the network 610 to be presented to the user.

An API server 618 and a web server 620 are coupled, and provide programmatic and web interfaces respectively, to the servers 622. For example, the API server 618 and the web server 620 may produce messages (e.g., RPC calls) in response to inputs received via the network, where the messages are supplied as input messages to workflows orchestrated by the processing system 606. The API server 618 and the web server 620 may also receive return values (return messages) from the processing system 606 and return results to calling parties (e.g., web clients 602 and client applications 604 running on client devices 608 and third-party applications 614) via the network 610. The servers 622 host the processing system 606, which includes components or applications in accordance with embodiments of the present disclosure as described above. The servers 622 are, in turn, shown to be coupled to one or more database servers 624 that facilitate access to information storage repositories (e.g., databases 626). In an example embodiment, the databases 626 includes storage devices that store information accessed and generated by the processing system 606, such as the historical transaction data 121 of FIG. 1 and other databases such as databases storing information associated with transactions processed by a business.

Additionally, a third-party application 614, executing on one or more third-party servers 621, is shown as having programmatic access to the networked system 616 via the programmatic interface provided by the API server 618. For example, the third-party application 614, using information retrieved from the networked system 616, may support one or more features or functions on a website hosted by a third-party. For example, the third-party application 614 may serve as a data source for retrieving, for example, historical transaction data 121.

Turning now specifically to the applications hosted by the client device 608, the web client 602 may access the various systems (e.g., the processing system 606) via the web interface supported by the web server 620. Similarly, the client application 604 (e.g., an “app”) may access the various services and functions provided by the processing system 606 via the programmatic interface provided by the API server 618. The client application 604 may be, for example, an “app” executing on the client device 608, such as an iOS or Android OS application to enable a user to access and input data on the networked system 616 in an offline manner and to perform batch-mode communications between the client application 604 and the networked system 616.

Further, while the network architecture 600 shown in FIG. 6 employs a client-server architecture, the present disclosure is not limited to such an architecture, and could equally well find application in a distributed, or peer-to-peer, architecture system, for example.

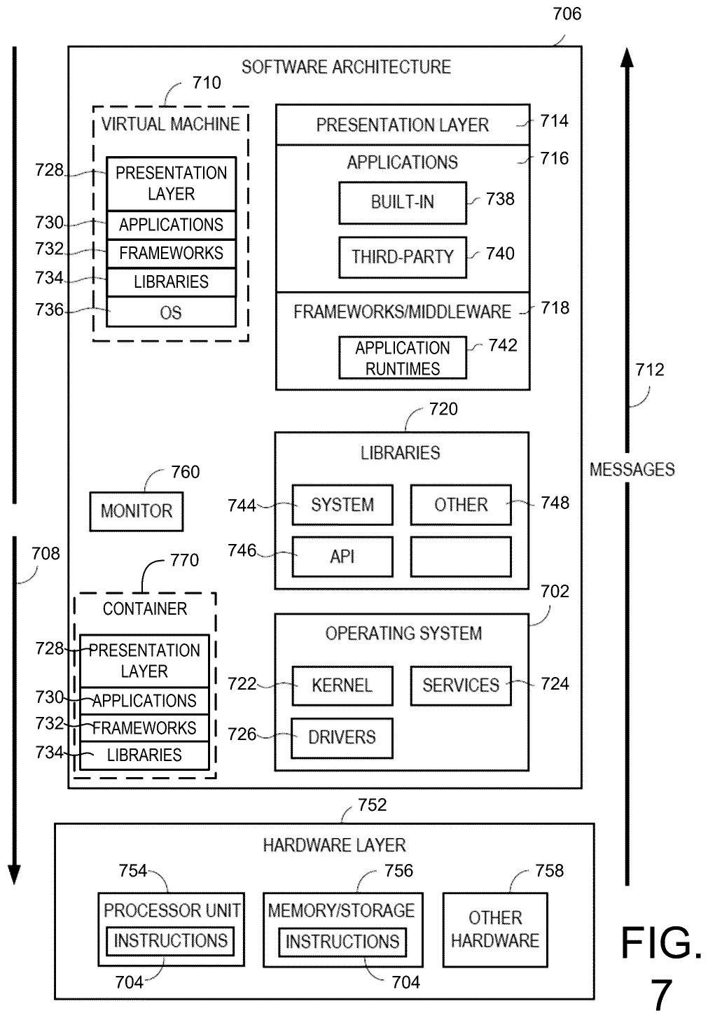

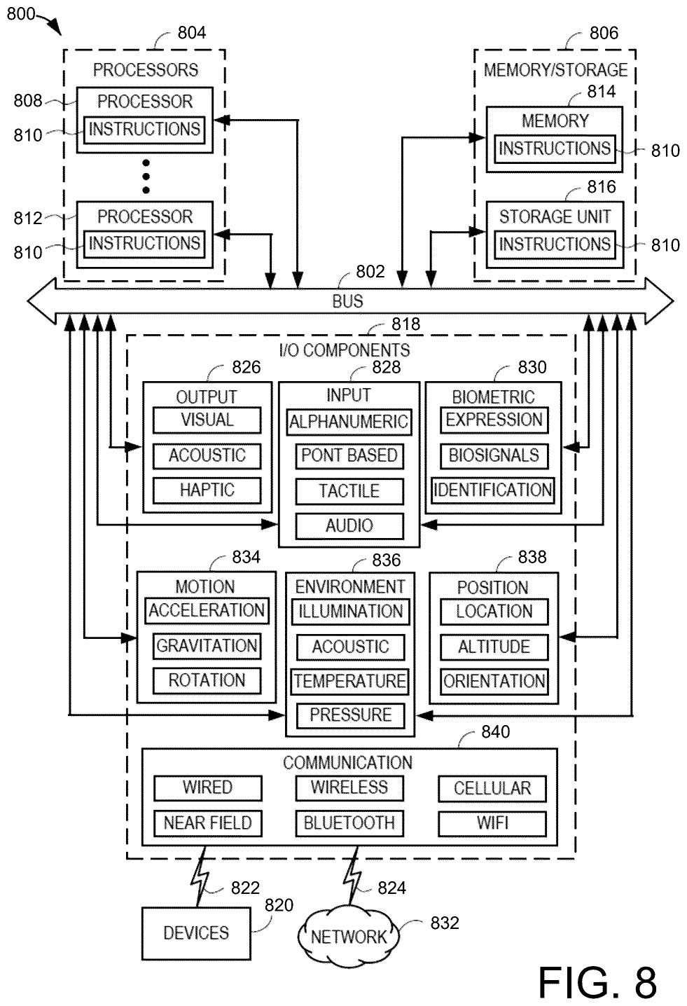

FIG. 7 is a block diagram illustrating an example software architecture 706, which may be used in conjunction with various hardware architectures herein described. FIG. 7 is a non-limiting example of a software architecture 706, and it will be appreciated that many other architectures may be implemented to facilitate the functionality described herein. The software architecture 706 may execute on hardware such as a machine 800 of FIG. 8 that includes, among other things, processors 804, memory/storage 806, and input/output (I/O) components 818. A representative hardware layer 752 is illustrated and can represent, for example, the machine 800 of FIG. 8. The representative hardware layer 752 includes a processor 754 having associated executable instructions 704. The executable instructions 704 represent the executable instructions of the software architecture 706, including implementation of the methods, components, and so forth described herein. The hardware layer 752 also includes non-transitory memory and/or storage modules as memory/storage 756, which also have the executable instructions 704. The hardware layer 752 may also include other hardware 758.

In the example architecture of FIG. 7, the software architecture 706 may be conceptualized as a stack of layers where each layer provides particular functionality. For example, the software architecture 706 may include layers such as an operating system 702, libraries 720, frameworks/middleware 718, applications 716 (such as the services of the revenue uplift prediction system 120), and a presentation layer 714. Operationally, the applications 716 and/or other components within the layers may invoke API calls 708 through the software stack and receive a response as messages 712 in response to the API calls 708. The layers illustrated are representative in nature, and not all software architectures have all layers. For example, some mobile or special-purpose operating systems may not provide a frameworks/middleware 718, while others may provide such a layer. Other software architectures may include additional or different layers.

The operating system 702 may manage hardware resources and provide common services. The operating system 702 may include, for example, a kernel 722, services 724, and drivers 726. The kernel 722 may act as an abstraction layer between the hardware and the other software layers. For example, the kernel 722 may be responsible for memory management, processor management (e.g., scheduling), component management, networking, security settings, and so on. The services 724 may provide other common services for the other software layers. The drivers 726 are responsible for controlling or interfacing with the underlying hardware. For instance, the drivers 726 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 720 provide a common infrastructure that is used by the applications 716 and/or other components and/or layers. The libraries 720 provide functionality that allows other software components to perform tasks in an easier fashion than by interfacing directly with the underlying operating system 702 functionality (e.g., kernel 722, services 724, and/or drivers 726). The libraries 720 may include system libraries 744 (e.g., C standard library) that may provide functions such as memory allocation functions, string manipulation functions, mathematical functions, and the like. In addition, the libraries 720 may include API libraries 746 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), and the like. The libraries 720 may also include a wide variety of other libraries 748 to provide many other APIs to the applications 716 and other software components/modules.

The frameworks/middleware 718 provide a higher-level common infrastructure that may be used by the applications 716 and/or other software components/modules. For example, the frameworks/middleware 718 may provide high-level resource management functions, web application frameworks, application runtimes 742 (e.g., a Java virtual machine or JVM), and so forth. The frameworks/middleware 718 may provide a broad spectrum of other APIs that may be utilized by the applications 716 and/or other software components/modules, some of which may be specific to a particular operating system or platform.

The applications 716 include built-in applications 738 and/or third-party applications 740. The applications 716 may use built-in operating system functions (e.g., kernel 722, services 724, and/or drivers 726), libraries 720, and frameworks/middleware 718 to create user interfaces to interact with users of the system. Alternatively, or additionally, in some systems, interactions with a user may occur through a presentation layer, such as the presentation layer 714. In these systems, the application/component “logic” can be separated from the aspects of the application/component that interact with a user.

Some software architectures use virtual machines. In the example of FIG. 7, this is illustrated by a virtual machine 710. The virtual machine 710 creates a software environment where applications/components can execute as if they were executing on a hardware machine (such as the machine 800 of FIG. 8, for example). The virtual machine 710 is hosted by a host operating system (e.g., the operating system 702 in FIG. 7) and typically, although not always, has a virtual machine monitor 760 (or hypervisor), which manages the operation of the virtual machine 710 as well as the interface with the host operating system (e.g., the operating system 702). A software architecture executes within the virtual machine 710 such as an operating system (OS) 736, libraries 734, frameworks 732, applications 730, and/or a presentation layer 728. These layers of software architecture executing within the virtual machine 710 can be the same as corresponding layers previously described or may be different.

Some software architectures use containers 770 or containerization to isolate applications. The phrase “container image” refers to a software package (e.g., a static image) that includes configuration information for deploying an application, along with dependencies such as software components, frameworks, or libraries that are required for deploying and executing the application. As discussed herein, the term “container” refers to an instance of a container image, and an application executes within an execution environment provided by the container. Further, multiple instances of an application can be deployed from the same container image (e.g., where each application instance executes within its own container). Additionally, as referred to herein, the term “pod” refers to a set of containers that accesses shared resources (e.g., network, storage), and one or more pods can be executed by a given computing node. A container 770 is similar to a virtual machine in that it includes a software architecture including libraries 734, frameworks 732, applications 730, and/or a presentation layer 728, but omits an operating system and, instead, communicates with the underlying host operating system 702.

FIG. 8 is a block diagram illustrating components of a machine 800, according to some example embodiments, able to read instructions from a non-transitory machine-readable medium (e.g., a computer-readable storage medium) and perform any one or more of the methodologies discussed herein. Specifically, FIG. 8 shows a diagrammatic representation of the machine 800 in the example form of a computer system, within which instructions 810 (e.g., software, a program, an application, an applet, an app, or other executable code) for causing the machine 800 to perform any one or more of the methodologies discussed herein may be executed. As such, the instructions 810 may be used to implement modules or components described herein. The instructions 810 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may include, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 810, sequentially or in parallel or concurrently, that specify actions to be taken by the machine 800. Further, while only a single machine 800 is illustrated, the term “machine” or “processing circuit” shall also be taken to include a collection of machines that individually or jointly execute the instructions 810 to perform any one or more of the methodologies discussed herein.

The machine 800 may include processors 804 (including processors 808 and 812), memory/storage 806, and I/O components 818, which may be configured to communicate with each other such as via a bus 802. The memory/storage 806 may include a memory 814, such as a main memory, or other memory storage, and a storage unit 816, both accessible to the processors 804 such as via the bus 802. The storage unit 816 and memory 814 store the instructions 810 embodying any one or more of the methodologies or functions described herein. The instructions 810 may also reside, completely or partially, within the memory 814, within the storage unit 816, within at least one of the processors 804 (e.g., within the processor's cache memory), or any suitable combination thereof, during execution thereof by the machine 800. Accordingly, the memory 814, the storage unit 816, and the memory of the processors 804 are examples of machine-readable media.

The I/O components 818 may include a wide variety of components to receive input, provide output, produce output, transmit information, exchange information, capture measurements, and so on. The specific I/O components 818 that are included in a particular machine will depend on the type of machine. For example, portable machines such as mobile phones may include a touch input device or other such input mechanisms, while a headless server machine will likely not include such a touch input device. It will be appreciated that the I/O components 818 may include many other components that are not shown in FIG. 8. The I/O components 818 are grouped according to functionality merely for simplifying the following discussion, and the grouping is in no way limiting. In various example embodiments, the I/O components 818 may include output components 826 and input components 828. The output components 826 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 818 may include biometric components 830, motion components 834, environment components 836, or position components 838, among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 834 may include acceleration sensor components (e.g., accelerometer), gravitation sensor components, rotation sensor components (e.g., gyroscope), and so forth. The environment components 836 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818 may include communication components 840 operable to couple the machine 800 to a network 832 or devices 820 via a coupling 824 and a coupling 822, respectively. For example, the communication components 840 may include a network interface component or other suitable device to interface with the network 832. In further examples, the communication components 840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 820 may be another machine or any of a wide variety of peripheral devices (e.g., a peripheral device coupled via a USB).

Moreover, the communication components 840 may detect identifiers or include components operable to detect identifiers. For example, the communication components 840 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840, such as location via Internet Protocol (IP) geo-location, location via Wi-Fi® signal triangulation, location via detecting an NFC beacon signal that may indicate a particular location, and so forth.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

According to one embodiment of the present disclosure, a method includes: receiving one or more features characterizing a first user; receiving one or more features characterizing a geographic region; receiving a selection of product offerings offered by a platform; computing, by a computer system including one or more processing circuits, a plurality of specific predictions corresponding to the selection of product offerings to be adopted by the first user, each specific prediction being computed for a corresponding product offering of the selection of product offerings by: selecting a specific model for the corresponding product offering corresponding to the one or more features characterizing the geographic region, the specific model being trained based on training data collected by the platform; and supplying the one or more features characterizing the first user to the specific model to compute the specific prediction for the corresponding product offering; computing, by the computer system, an aggregated prediction from adopting the selection of product offerings based on the plurality of specific predictions, the aggregated prediction being smaller than the sum of the plurality of specific predictions for the selection of product offerings; and generating, by the computer system, a report of the aggregated prediction from adopting the selection of product offerings, the aggregated prediction being represented as a range of values.

The specific model may include one or more sub-models trained based on historical data associated with the corresponding product offering, a sub-model of the one or more sub-models being configured to compute an estimate having a distribution of values and a variance associated with the distribution of values, the specific model being configured to combine estimates from the one or more sub-models to compute the specific prediction of the specific model.

The one or more sub-models may include a holdback sub-model trained based on the historical data, and the historical data may be based on the corresponding product offering being hidden from a plurality of second users.

The one or more sub-models may include a difference-in-difference sub-model trained based on matching pairs of first users that have matching first user features in the historical data, and the difference-in-difference sub-model may be configured to compute an estimate for the corresponding product offering based on identifying a pair of first user features matching the one or more features characterizing the first user.

The specific model may be configured to combine predictions from the one or more sub-models based on inverse-variance weighting based on the variance of the distribution of values of the estimate.

The selection of product offerings may include a plurality of product features of the platform.

The computing the aggregated prediction may include computing an overlap of the plurality of specific predictions associated with different payment providers among the selection of product offerings.

The computing the aggregated prediction may include adding midpoints of a corresponding interval for each of the plurality of specific predictions.

The corresponding interval for each of the plurality of specific predictions may be a confidence interval computed based on the training data.

According to one embodiment of the present disclosure, a system includes: a processor; and a memory storing instructions that, when executed by the processor, cause the processor to: receive one or more features characterizing a first user; receive one or more features characterizing a geographic region; receive a selection of product offerings offered by a platform; compute a plurality of specific predictions corresponding to the selection of product offerings to be adopted by the first user, each specific prediction being represented as a range of values and being computed for a corresponding product offering of the selection of product offerings by: selecting a specific model for the corresponding product offering corresponding to the one or more features characterizing the geographic region, the specific model being trained based on training data collected by the platform; and supplying the one or more features characterizing the first user to the specific model to compute the specific prediction for the corresponding product offering; compute an aggregated prediction from adopting the selection of product offerings based on aggregating the range of values for each of the plurality of specific predictions, the aggregated prediction being smaller than the sum of the plurality of specific predictions for the selection of product offerings; and generate a report of the aggregated prediction from adopting the selection of product offerings, the aggregated prediction being represented as a range of values.

The specific model may include one or more sub-models trained based on historical data associated with the corresponding product offering, a sub-model of the one or more sub-models being configured to compute an estimate having a distribution of values and a variance associated with the distribution of values, the specific model being configured to combine estimates from the one or more sub-models to compute the specific prediction of the specific model, the range of values of the specific prediction being computed based on the distribution of values and variance of the estimate.

The one or more sub-models may include a holdback sub-model trained based on the historical data, and the historical data may be based on the corresponding product offering being hidden from a plurality of second users.

The one or more sub-models may include a difference-in-difference sub-model trained based on matching pairs of first users that have matching first user features in the historical data, and the difference-in-difference sub-model may be configured to compute an estimate for the corresponding product offering based on identifying a pair of first user features matching the one or more features characterizing the first user.

The specific model may be configured to combine predictions from the one or more sub-models based on inverse-variance weighting based on the variance of the distribution of values of the estimate.

The selection of product offerings may include a plurality of product features of the platform.

The instructions to compute the aggregated prediction may include instructions that, when executed by the processor, cause the processor to compute an overlap of the plurality of specific predictions associated with different payment providers among the selection of product offerings.

The instructions to compute the aggregated prediction may include instructions that, when executed by the processor, cause the processor to add midpoints of a corresponding interval for each of the plurality of specific predictions.

The corresponding interval for each of the plurality of specific predictions may be a confidence interval computed based on the training data.

According to one embodiment of the present disclosure, a non-transitory computer-readable medium stores instructions that, when executed by a processor, cause the processor to: receive one or more features characterizing a first user; receive a selection of product offerings offered by a platform; compute a plurality of specific predictions corresponding to the selection of product offerings to be adopted by the first user, each specific prediction being represented as a range of values and being computed for a corresponding product offering of the selection of product offerings by: selecting a specific model for the corresponding product offering, the specific model being trained based on training data collected by the platform; and supplying the one or more features characterizing the first user to the specific model to compute the specific prediction for the corresponding product offering; compute an aggregated prediction from adopting the selection of product offerings based on aggregating the range of values for each of the plurality of specific predictions; and generate a report of the aggregated prediction from adopting the selection of product offerings, the aggregated prediction being represented as a range of values.

The selection of product offerings may be selected from among a plurality of available payment methods and product features offered by the platform.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method comprising:
receiving one or more features characterizing a first user;
receiving one or more features characterizing a geographic region;
receiving a selection of product offerings offered by a platform;
computing, by a computer system comprising one or more processing circuits, a plurality of specific predictions corresponding to the selection of product offerings to be adopted by the first user, each specific prediction being computed for a corresponding product offering of the selection of product offerings by:
selecting a specific model for the corresponding product offering corresponding to the one or more features characterizing the geographic region, the specific model being trained based on training data collected by the platform; and
supplying the one or more features characterizing the first user to the specific model to compute the specific prediction for the corresponding product offering;
computing, by the computer system, an aggregated prediction from adopting the selection of product offerings based on the plurality of specific predictions, the aggregated prediction being smaller than the sum of the plurality of specific predictions for the selection of product offerings; and
generating, by the computer system, a report of the aggregated prediction from adopting the selection of product offerings, the aggregated prediction being represented as a range of values.

2. The method of claim 1, wherein the specific model comprises one or more sub-models trained based on historical data associated with the corresponding product offering, a sub-model of the one or more sub-models being configured to compute an estimate having a distribution of values and a variance associated with the distribution of values,
the specific model being configured to combine estimates from the one or more sub-models to compute the specific prediction of the specific model.

3. The method of claim 2, wherein the one or more sub-models comprise a holdback sub-model trained based on the historical data, and
wherein the historical data is based on the corresponding product offering being hidden from a plurality of second users.

4. The method of claim 2, wherein the one or more sub-models comprise a difference-in-difference sub-model trained based on matching pairs of first users that have matching first user features in the historical data, and
wherein the difference-in-difference sub-model is configured to compute an estimate for the corresponding product offering based on identifying a pair of first user features matching the one or more features characterizing the first user.

5. The method of claim 2, wherein the specific model is configured to combine predictions from the one or more sub-models based on inverse-variance weighting based on the variance of the distribution of values of the estimate.

6. The method of claim 1, wherein the selection of product offerings comprises a plurality of product features of the platform.

7. The method of claim 1, wherein the computing the aggregated prediction comprises computing an overlap of the plurality of specific predictions associated with different payment providers among the selection of product offerings.

8. The method of claim 1, wherein the computing the aggregated prediction comprises adding midpoints of a corresponding interval for each of the plurality of specific predictions.

9. The method of claim 8, wherein the corresponding interval for each of the plurality of specific predictions is a confidence interval computed based on the training data.

10. A system comprising:
a processor; and
a memory storing instructions that, when executed by the processor, cause the processor to:
receive one or more features characterizing a first user;
receive one or more features characterizing a geographic region;
receive a selection of product offerings offered by a platform;
compute a plurality of specific predictions corresponding to the selection of product offerings to be adopted by the first user, each specific prediction being represented as a range of values and being computed for a corresponding product offering of the selection of product offerings by:
selecting a specific model for the corresponding product offering corresponding to the one or more features characterizing the geographic region, the specific model being trained based on training data collected by the platform; and
supplying the one or more features characterizing the first user to the specific model to compute the specific prediction for the corresponding product offering;
compute an aggregated prediction from adopting the selection of product offerings based on aggregating the range of values for each of the plurality of specific predictions, the aggregated prediction being smaller than the sum of the plurality of specific predictions for the selection of product offerings; and
generate a report of the aggregated prediction from adopting the selection of product offerings, the aggregated prediction being represented as a range of values.

11. The system of claim 10, wherein the specific model comprises one or more sub-models trained based on historical data associated with the corresponding product offering, a sub-model of the one or more sub-models being configured to compute an estimate having a distribution of values and a variance associated with the distribution of values,
the specific model being configured to combine estimates from the one or more sub-models to compute the specific prediction of the specific model, the range of values of the specific prediction being computed based on the distribution of values and variance of the estimate.

12. The system of claim 11, wherein the one or more sub-models comprise a holdback sub-model trained based on the historical data, and
wherein the historical data is based on the corresponding product offering being hidden from a plurality of second users.

13. The system of claim 11, wherein the one or more sub-models comprise a difference-in-difference sub-model trained based on matching pairs of first users that have matching first user features in the historical data, and
wherein the difference-in-difference sub-model is configured to compute an estimate for the corresponding product offering based on identifying a pair of first user features matching the one or more features characterizing the first user.

14. The system of claim 11, wherein the specific model is configured to combine predictions from the one or more sub-models based on inverse-variance weighting based on the variance of the distribution of values of the estimate.

15. The system of claim 10, wherein the selection of product offerings comprises a plurality of product features of the platform.

16. The system of claim 10, wherein the instructions to compute the aggregated prediction comprise instructions that, when executed by the processor, cause the processor to compute an overlap of the plurality of specific predictions associated with different payment providers among the selection of product offerings.

17. The system of claim 10, wherein the instructions to compute the aggregated prediction comprise instructions that, when executed by the processor, cause the processor to add midpoints of a corresponding interval for each of the plurality of specific predictions.

18. The system of claim 17, wherein the corresponding interval for each of the plurality of specific predictions is a confidence interval computed based on the training data.

19. A non-transitory computer-readable medium storing instructions that, when executed by a processor, cause the processor to:
receive one or more features characterizing a first user;
receive a selection of product offerings offered by a platform;
compute a plurality of specific predictions corresponding to the selection of product offerings to be adopted by the first user, each specific prediction being represented as a range of values and being computed for a corresponding product offering of the selection of product offerings by:
selecting a specific model for the corresponding product offering, the specific model being trained based on training data collected by the platform; and
supplying the one or more features characterizing the first user to the specific model to compute the specific prediction for the corresponding product offering;
compute an aggregated prediction from adopting the selection of product offerings based on aggregating the range of values for each of the plurality of specific predictions; and
generate a report of the aggregated prediction from adopting the selection of product offerings, the aggregated prediction being represented as a range of values.

20. The non-transitory computer-readable medium of claim 19, wherein the selection of product offerings is selected from among a plurality of available payment methods and product features offered by the platform.
